(19) United States
(12) Patent Application Publication
(10) Pub. No.: US 2017/0235178 A1
(43) Pub. Date: Aug. 17, 2017

(54) COA SUBSTRATE, LIQUID CRYSTAL DISPLAY PANEL AND LIQUID CRYSTAL DISPLAY DEVICE

(71) Applicant: SHENZHEN CHINA STAR OPTOELECTRONICS TECHNOLOGY CO. LTD., Shenzhen, Guangdong (CN)

(72) Inventors: Siyang LIU, Shenzhen, Guangdong (CN); Zui WANG, Shenzhen, Guangdong (CN); Shihhsun LO, Shenzhen, Guangdong (CN)

(21) Appl. No.: 14/906,080

(22) PCT Filed: Dec. 24, 2015
(86) PCT No.: PCT/CN2015/098774

§ 371 Date: Jan. 19, 2016

(30) Foreign Application Priority Data
Nov. 27, 2015 (CN) 201510846887.0

(51) Int. Cl. G02F 1/1339; G02F 1/1343; G02F 1/1335; G02F 1/1368; G02F 1/1362

(52) U.S. Cl. CPC G02F 1/13394; G02F 1/1368; G02F 1/136286; G02F 1/133514; G02F 1/13439; G02F 2001/133354

(57) ABSTRACT

A COA substrate is provided. The COA substrate includes a substrate, a metal layer, a thin-film transistor, a color filter, a transparency electrode, and a spacer. The color filter herein has a plurality of through holes disposed thereon. The spacer is disposed in a corresponding region of the through hole of the color filter. The present invention can better avoid the vacuum bubbles arising in the liquid crystal layer by disposing the spacer in the region of the through hole, thereby enhancing the image display quality of the liquid crystal display panel.

### BACKGROUND OF THE INVENTION

Field of Invention

The present invention relates to a liquid crystal display technology, and in particular to a COA substrate, a liquid crystal display panel, and a liquid crystal display device.

Description of Prior Art

In the liquid crystal display technology, in order to avoid a problem of misalignment between color filter resists on a color filter substrate and pixel units on an array substrate when assembling the array substrate and the color filter substrate into a cell, LCD panel manufacturers develop a COA substrate (Color Filter on Array); that is, the color filter resists are directly disposed on the array substrate. This can better solve the problem of the misalignment between the color filter substrate and the array substrate.

Referring to FIG. 1, FIG. 1 is a schematic drawing illustrating a conventional liquid crystal display panel. The liquid crystal display panel includes a COA substrate 10 and a corresponding substrate 16; the COA substrate 10 includes a data line (not shown in the drawing), a scanning line (not shown in the drawing), a thin-film transistor 11, a color filter 12, a transparency electrode 13, and a spacer 14. The data line herein is utilized to transmit data signals. The scanning line is utilized to transmit scanning signals. The thin-film transistor 11 is utilized to transmit the data signals to the transparency electrode 13 under the control of the scanning signals. The transparent electrode 13 is utilized to drive the liquid crystal molecules 15 to carry out the twist. The color filter 12 is utilized to form an emergent light with various colors. The spacer 14 is utilized to keep a distance between the COA substrate 10 and the corresponding substrate 16.

Since the transparent electrode 13 needs to be disposed on the color filter 12, so the color filter 12 is provided with a plurality of through hole 121 to transparency electrode 13 is used to transfer data signals, the color filter 12 has a plurality of through holes 121 disposed thereon and utilized to transmit data signals (i.e. coupling the transparency electrode 13 and the data line) for the transparency electrode 13. This results in a poor fluidity of the liquid crystal molecules 15 in the through holes 121 of the COA substrate 10, and vacuum, bubbles are prone to occur, thus affecting the image display quality of the corresponding liquid crystal display panel.

Therefore, there is a significant need to provide a COA substrate, a liquid crystal display panel, and a liquid crystal display device for solving the problem existing in the prior art.

### SUMMARY OF THE INVENTION

Accordingly, the present invention provides a COA substrate, a liquid crystal display panel, and a liquid crystal display device, which the vacuum bubbles are not easy to occur in the liquid crystal layer such that the image display quality is better, thereby solving the technical problem that the vacuum bubbles are prone to occur in the liquid crystal layer of the conventional liquid crystal display panel thus to affect the image display quality.

An embodiment of the present invention provides a COA substrate, which includes: a substrate; a metal layer disposed on the substrate, utilized to form a data line for transmitting data signals and a scanning line for transmitting scanning signals; a thin-film transistor disposed on the substrate, utilized to transmit the data signals to a transparency electrode under control of the scanning signals; a color filter disposed on the metal layer and the thin-film transistor, utilized to transform an incident light into an emergent light with various colors, and having a plurality of through holes; the transparency electrode disposed on the color filter and coupled to the thin-film transistor via the through hole; and a spacer disposed in a corresponding region of the through hole of the color filter, utilized to keep a distance between the COA substrate and a corresponding substrate.

In the COA substrate of the present invention, a projection of the spacer on the substrate covers a projection of the through hole on the substrate.

In the COA substrate of the present invention, a projected area of the spacer on the substrate is slightly larger than a projected area of the through hole on the substrate.

In the COA substrate of the present invention, the color filter includes a green color resist, a green color resist, a blue color resist, and a black color resist.

An embodiment of the present invention further provides a liquid crystal display panel, which includes a COA substrate, a corresponding substrate, and a liquid crystal layer disposed between the COA substrate and the corresponding substrate.

The COA substrate herein comprises: a substrate; a metal layer disposed on the substrate, utilized to form a data line for transmitting data signals and a scanning line for transmitting scanning signals; a thin-film transistor disposed on the substrate, utilized to transmit the data signals to a transparency electrode under control of the scanning signals; a color filter disposed on the metal layer and the thin-film transistor, utilized to transform an incident light into an emergent light with various colors, and having a plurality of through holes; the transparency electrode disposed on the color filter and coupled to the thin-film transistor via the through hole; and a spacer disposed in a corresponding region of the through hole of the color filter, utilized to keep a distance between the COA substrate and a corresponding substrate.

In the liquid crystal display panel of the present invention, a projection of the spacer on the substrate covers a projection of the through hole on the substrate.

In the liquid crystal display panel of the present invention, a projected area of the spacer on the substrate is slightly larger than a projected area of the through hole on the substrate.

In the liquid crystal display panel of the present invention, the color filter includes a green color resist, a green color resist, a blue color resist, and a black color resist. An embodiment of the present invention further provides a liquid crystal display device, which includes a backlight source and an liquid crystal display panel; wherein the liquid crystal display panel comprises a COA substrate, a corresponding substrate, and a liquid crystal layer disposed between the COA substrate and the corresponding substrate; wherein the COA substrate comprises: a substrate; a metal layer disposed on the substrate, utilized to form a data line for transmitting data signals and a scanning line for transmitting scanning signals; a thin-film transistor disposed on the substrate, utilized to transmit the data signals to a transparency electrode under control of the scanning signals; a color filter disposed on the metal layer and the thin-film transistor, utilized to transform an incident light into an emergent light with various colors, and having a plurality of through holes; the transparency electrode disposed on the color filter and coupled to the thin-film transistor via the through hole; and a spacer disposed in a corresponding region of the through hole of the color filter, utilized to keep a distance between the COA substrate and a corresponding substrate.

In the liquid crystal display device of the present invention, a projection of the spacer on the substrate covers a projection of the through hole on the substrate.

In the liquid crystal display device of the present invention, a projected area of the spacer on the substrate is slightly larger than a projected area of the through hole on the substrate.

In the liquid crystal display device of the present invention, the color filter includes a green color resist, a green color resist, a blue color resist, and a black color resist.

The COA substrate, liquid crystal display panel and liquid crystal display device of the present invention can better avoid the vacuum bubbles arising in the liquid crystal layer by disposing the spacer in the region of the through hole, thereby enhancing the image display quality of the liquid crystal display panel.

The technical problem that the vacuum bubbles are prone to occur in the liquid crystal layer of the conventional liquid crystal display panel thus to affect the image display quality is solved.

### BRIEF DESCRIPTION OF THE DRAWINGS

To describe the technical solutions in the embodiments of the present application or in the prior art more clearly, the following briefly introduces the accompanying drawings required for describing the embodiments or the prior art. Apparently, the accompanying drawings in the following description show merely some embodiments of the present application, and a person of ordinary skill in the art may still derive other drawings from these accompanying drawings without creative efforts.

FIG. 1 is a schematic drawing illustrating a conventional liquid crystal display panel; and

FIG. 2 is a schematic drawing illustrating a liquid crystal display panel according to a preferred embodiment of the present invention.

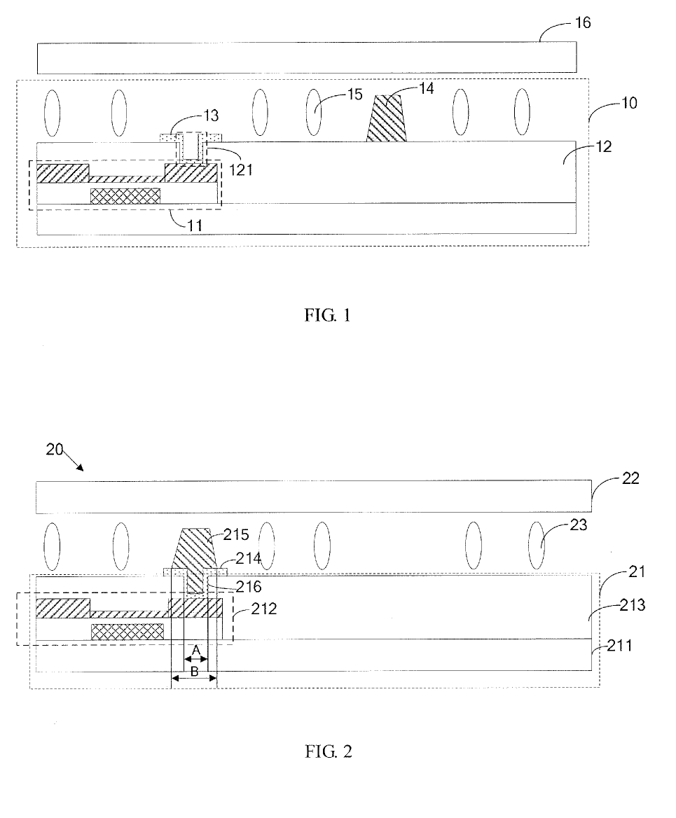

### DETAILED DESCRIPTION OF THE PREFERRED EMBODIMENTS

Please refer to the drawings in the drawings. The same reference numbers throughout the drawings represent the same components. The following description is based on illustrated embodiments of the invention and should not be taken as limiting the invention with regard to alternative embodiments that are not explicitly described herein.

Referring to FIG. 2, FIG. 2 is a schematic drawing illustrating a liquid crystal display panel according to a preferred embodiment of the present invention. The liquid crystal display panel 20 of the preferred embodiment includes a COA substrate 21, a corresponding substrate 22, and a liquid crystal layer 23 disposed between the COA substrate 21 and the corresponding substrate 22.

The COA substrate 21 herein includes a substrate 211, a metal layer (not shown in the drawing), a thin-film transistor 212, a color filter 213, a transparency electrode 214, and a spacer 215. The metal layer is disposed on the substrate 211 and utilized to form a data line for transmitting data signals and a scanning line for transmitting scanning signals. The thin-film transistor 212 is disposed on the substrate 211 and utilized to transmit the data signals to the transparency electrode 214 under the control of the scanning signals. The color filter 213 is disposed on the metal layer and the thin-film transistor 212 and utilized to transform an incident light into an emergent light with various colors, and has a plurality of through holes 216. The color filter 213 may include a red color resist, a green color resist and a blue color resist (i.e. color resists) disposed alternately, and black color resists disposed between the different color resists. The transparency electrode 214 is disposed on the color filter 213 and coupled to the thin-film transistor 212 via the through hole 216. The spacer is disposed in a corresponding region of the through hole 216 of the color filter 213, and utilized to keep a distance between the COA substrate 21 and the corresponding substrate 22.

As shown in FIG. 2, a projection region of the spacer 215 on the substrate 211 is “B”, and a projection region of the through hole 216 on the substrate 211 is “A”. The projection region B of the spacer 215 on the substrate 211 completely covers the projection region A of the through hole 216 on the substrate 211, and area of the projection region B of the spacer 215 on the substrate 211 is slightly larger than area of the projection region A of the through hole 216 on the substrate 211, in order to ensure the completeness of the spacer 215 covering the through hole 216.

In fabricating the COA substrate 21 of the preferred embodiment, the metal layer is fabricated on the substrate 211 first, and then the metal layer is patterned to form the data line for transmitting the data signals and the scanning line for transmitting scanning signals. An insulation layer needs to be utilized to isolate the data line and the scanning line herein.

While forming the data line, the thin-film transistor 212 is fabricated on the substrate 211, so as to control pixel units of the corresponding liquid crystal display panel. The thin-film transistor 212 includes a drain, a gate, and a source, where the source is coupled to the data line; the drain is coupled to the transparency electrode; and the gate is coupled to the scanning line.

Subsequently, the color filter 213, such as the red color resist, the blue color resist, the red color resist, and the black color resist can be disposed on the metal layer and the thin-film transistor 212. Meanwhile, the plurality of through holes 126 are formed on the color filter 213. The position of the through hole 216 corresponds to the position of the drain of thin-film transistor 212.

Then the transparency electrode 214 is fabricated on the color filter 213, and the transparency electrode 214 is coupled to the drain of the thin-film transistor 212 via the through hole 216 on the color filter 213.

Finally, the spacer 215 is fabricated in the corresponding region of the through hole 216 of the color filter 213. The spacer 215 completely fills the through hole 216. That is, this ensures that there is no gap between the spacer 215 and the transparency electrode 214 within the through hole 216. The projection region B of the spacer 215 on the substrate 211 completely covers the projection region A of the through hole 216 on the substrate 211, and area of the projection region of the spacer 215 on the substrate 211 is slightly larger than area of the projection region of the through hole 216 on the substrate 211. Accordingly, recesses on the surface of the array substrate 21 are removed, so that the surface of the array substrate 21 is smoother such that the spacer does not affect the image display too much.

Therefore, the disposing of the spacer of the COA substrate of the liquid crystal display panel of the preferred embodiment enhances the fluidity of the liquid crystal molecules in the liquidity liquid crystal layer 23, avoids the vacuum bubbles occurring in the liquid crystal layer 23, and improves the display quality of the liquid crystal display panel.

The present invention further provides a liquid crystal display device. The liquid crystal display device includes a backlight source and a liquid crystal display panel. The liquid crystal display panel includes a COA substrate, a corresponding substrate, and a liquid crystal layer disposed between the COA substrate and the corresponding substrate.

The COA substrate includes a substrate, a metal layer, a thin-film transistor, a color filter, a transparency electrode, and a spacer. The metal layer is disposed on the substrate and utilized to form a data line for transmitting data signals and a scanning line for transmitting scanning signals. The thin-film transistor is disposed on the substrate and utilized to transmit the data signals to the transparency electrode under the control of the scanning signals. The color filter is disposed on the metal layer and the thin-film transistor and utilized to transform an incident light into an emergent light with various colors, and has a plurality of through holes. The color filter may include a red color resist, a green color resist and a blue color resist disposed alternately, and black color resists disposed between the different color resists. The transparency electrode is disposed on the color filter and coupled to the thin-film transistor via the through hole. The spacer is disposed in a corresponding region of the through hole of the color filter, and utilized to keep a distance between the COA substrate and the corresponding substrate.

Preferably, a projection of the spacer on the substrate covers a projection of the through hole on the substrate.

Preferably, a projected area of the spacer on the substrate is slightly larger than a projected area of the through hole on the substrate.

The specific operating principle of the liquid crystal display device is the same or similar to the relevant description in the above-mentioned preferred embodiment of the liquid crystal display panel. For details, please refer to the relevant description of the above-mentioned liquid crystal display panel of the preferred embodiments.

The COA substrate, liquid crystal display panel and liquid crystal display device of the present invention can better avoid the vacuum bubbles arising in the liquid crystal layer by disposing the spacer in the region of the through hole, thereby enhancing the image display quality of the liquid crystal display panel. The technical problem that the vacuum bubbles are prone to occur in the liquid crystal layer of the conventional liquid crystal display panel thus to affect the image display quality is solved.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A COA substrate, comprising:
a substrate;
a metal layer disposed on the substrate, utilized to form a data line for transmitting data signals and a scanning line for transmitting scanning signals;
a thin-film transistor disposed on the substrate, utilized to transmit the data signals to a transparency electrode under control of the scanning signals;
a color filter disposed on the metal layer and the thin-film transistor, utilized to transform an incident light into an emergent light with various colors, and having a plurality of through holes;
the transparency electrode disposed on the color filter and coupled to the thin-film transistor via the through hole; and
a spacer disposed in a corresponding region of the through hole of the color filter, utilized to keep a distance between the COA substrate and a corresponding substrate.

2. The COA substrate according to claim 1, wherein a projection of the spacer on the substrate covers a projection of the through hole on the substrate.

3. The COA substrate according to claim 2, wherein a projected area of the spacer on the substrate is slightly larger than a projected area of the through hole on the substrate.

4. The COA substrate according to claim 1, wherein the color filter includes a green color resist, a green color resist, a blue color resist, and a black color resist.

5. A liquid crystal display panel, comprising a COA substrate, a corresponding substrate, and a liquid crystal layer disposed between the COA substrate and the corresponding substrate;
wherein the COA substrate comprises:
a substrate;
a metal layer disposed on the substrate, utilized to form a data line for transmitting data signals and a scanning line for transmitting scanning signals;
a thin-film transistor disposed on the substrate, utilized to transmit the data signals to a transparency electrode under control of the scanning signals;
a color filter disposed on the metal layer and the thin-film transistor, utilized to transform an incident light into an emergent light with various colors, and having a plurality of through holes;
the transparency electrode disposed on the color filter and coupled to the thin-film transistor via the through hole; and
a spacer disposed in a corresponding region of the through hole of the color filter, utilized to keep a distance between the COA substrate and a corresponding substrate.

6. The liquid crystal display panel according to claim 5, wherein a projection of the spacer on the substrate covers a projection of the through hole on the substrate.

7. The liquid crystal display panel according to claim 6, wherein a projected area of the spacer on the substrate is slightly larger than a projected area of the through hole on the substrate.

8. The liquid crystal display panel according to claim 5, wherein the color filter includes a green color resist, a green color resist, a blue color resist, and a black color resist.

9. A liquid crystal display device, comprising a backlight source and a liquid crystal display panel; wherein the liquid crystal display panel comprises a COA substrate, a corresponding substrate, and a liquid crystal layer disposed between the COA substrate and the corresponding substrate;
wherein the COA substrate comprises:
a substrate;
a metal layer disposed on the substrate, utilized to form a data line for transmitting data signals and a scanning line for transmitting scanning signals;
a thin-film transistor disposed on the substrate, utilized to transmit the data signals to a transparency electrode under control of the scanning signals;
a color filter disposed on the metal layer and the thin-film transistor, utilized to transform an incident light into an emergent light with various colors, and having a plurality of through holes;
the transparency electrode disposed on the color filter and coupled to the thin-film transistor via the through hole; and
a spacer disposed in a corresponding region of the through hole of the color filter, utilized to keep a distance between the COA substrate and a corresponding substrate.

10. The liquid crystal display device according to claim 9, wherein a projection of the spacer on the substrate covers a projection of the through hole on the substrate.

11. The liquid crystal display device according to claim 10, wherein a projected area of the spacer on the substrate is slightly larger than a projected area of the through hole on the substrate.

12. The liquid crystal display device according to claim 9, wherein the color filter includes a green color resist, a green color resist, a blue color resist, and a black color resist.
